(19) United States
(12) Patent Application Publication
(10) Pub. No.: US 2020/0393289 A1
(43) Pub. Date: Dec. 17, 2020

(54) MEASUREMENT SYSTEM, CORRECTION PROCESSING APPARATUS, CORRECTION PROCESSING METHOD, AND COMPUTER-READABLE RECORDING MEDIUM

(71) Applicant: NEC Corporation, Minato-ku, Tokyo (JP)

(72) Inventors: Masahiko OHTA, Tokyo (JP); Gaku NAKANO, Tokyo (JP); Kazuhito MURATA, Tokyo (JP)

(73) Assignee: NEC Corporation, Minato-ku, Tokyo (JP)

(21) Appl. No.: 16/764,061

(22) PCT Filed: Nov. 14, 2017
(86) PCT No.: PCT/JP2017/040944

§ 371 Date: May 14, 2020

(51) Int. Cl. G01H 9/00; G01M 99/00

(52) U.S. Cl. CPC G01H 9/00; G01M 99/00

(57) ABSTRACT

A measurement system 100 includes: a measurement apparatus 20 that measures vibrations of an object 40; an imaging apparatus 30 that is fixed to the measurement apparatus 20 so as to be able to capture an image of a preset reference face 50; and a correction processing apparatus 10. The correction processing apparatus 10 includes: a displacement calculation unit 11 that calculates a displacement of the reference face 50 based on time-series images of the reference face 50; a movement amount calculation unit 12 that calculates an amount of movement of the measurement apparatus 30 relative to the reference face 50, based on the displacement and preset imaging information regarding the imaging apparatus 30; and a correction processing unit 13 that corrects vibrations measured by the measurement apparatus 20, so as to be vibrations relative to the reference face 50, using the calculated amount of movement.

### TECHNICAL FIELD

The present invention relates to a measurement system, and a correction processing apparatus and a correction processing method used therefor. Furthermore, the present invention relates to a computer-readable recording medium on which a program for realizing them is recorded.

### BACKGROUND ART

Conventionally, a technique has been proposed for contactlessly measuring mechanical vibrations of an object from a remote place without touching the object. Such a technique makes it unnecessary to attach or detach a sensor for detecting vibrations, and realizes efficient vibration measurement. Therefore, there is a need for such a technique especially in the field of maintenance and management, and abnormality detection, of infrastructural components such as bridges, roads, buildings, and facilities.

For example, Patent Document 1 discloses a vibration measurement apparatus that employs an imaging apparatus. The vibration measurement apparatus disclosed in Patent Document 1 measures vibrations of an object by acquiring time-series images of the object from the imaging apparatus, and performing image processing on the acquired time-series images. However, there is a problem in that the vibration measurement apparatus disclosed in Patent Document 1 can only measure vibration components in two-dimensional directions within the images, and cannot measure vibration components in the optical axis direction of the imaging apparatus.

Considering this problem, Patent Document 2 discloses a vibration measurement apparatus that employs, in addition to an imaging apparatus, a distance measurement apparatus such as a laser distance meter or an ultrasonic distance meter. The vibration measurement apparatus disclosed in Patent Document 2 can measure not only vibration components in two-dimensional directions within the images, but also vibration components in the optical axis direction of the imaging apparatus, using the distance measurement apparatus. Therefore, the vibration measurement apparatus can measure vibrations of the object in three-dimensional directions.

### LIST OF RELATED ART DOCUMENTS

### Patent Documents

Patent Document 1: Japanese Patent Laid-Open Publication No. 2003-156389

Patent Document 2: Japanese Patent Laid-Open Publication No. 2005-283440

### SUMMARY OF INVENTION

### Problems to be Solved by the Invention

When the object to be subjected to vibration measurement is an infrastructural component, the vibration measurement apparatus may be installed in a location that is likely to be vibrated due to the configuration of the infrastructural component, and may itself be vibrated. For example, if the object is a bridge, the vibration measurement apparatus may be installed on an inspection passage or a structural member of the bridge. In such a case, if the bridge is vibrated due to a vehicle or the like passing through it, the vibration measurement apparatus itself is also vibrated. If the vibration measurement apparatus itself is vibrated, it becomes difficult to accurately measure the vibration components of the object alone because the vibrations of the vibration measurement apparatus are superimposed on the vibrations of the object and observed.

An example object of the invention is to provide a measurement system, a correction processing apparatus, a correction processing method, and a computer-readable recording medium that can solve the above-described problems and with which vibrations of an object can be accurately measured even if the measurement apparatus that measures vibrations of the object is installed in a location that is likely to be vibrated.

### Means for Solving the Problems

To achieve the object described above, a measurement system according to one aspect of the invention includes: a measurement apparatus that measures vibrations of an object; an imaging apparatus that is fixed to the measurement apparatus so as to be able to capture an image of a preset reference face; and a correction processing apparatus,

the correction processing apparatus including:

a displacement calculation unit that calculates a displacement of the reference face based on time-series images of the reference face output from the imaging apparatus;

a movement amount calculation unit that calculates an amount of movement of the measurement apparatus relative to the reference face, based on the displacement and preset imaging information regarding the imaging apparatus; and

a correction processing unit that corrects vibrations measured by the measurement apparatus, so as to be vibrations relative to the reference face, using the amount of movement.

To achieve the object described above, a correction processing apparatus according to one aspect of the invention is an apparatus that corrects a result of measurement performed by a measurement apparatus that measures vibrations of an object, the correction processing apparatus including:

a displacement calculation unit that calculates a displacement of a preset reference face based on time-series images of the reference face output from an imaging apparatus that is fixed to the measurement apparatus so as to be able to capture an image of the reference face;

a movement amount calculation unit that calculates an amount of movement of the measurement apparatus relative to the reference face, based on the displacement and preset imaging information regarding the imaging apparatus; and

a correction processing unit that corrects vibrations measured by the measurement apparatus, so as to be vibrations relative to the reference face, using the amount of movement.

Also, to achieve the object described above, a correction processing method according to one aspect of the invention is a method for correcting a result of measurement performed by a measurement apparatus that measures vibrations of an object, the correction processing method including:

(a) a step of calculating a displacement of a preset reference face based on time-series images of the reference face output from an imaging apparatus that is fixed to the measurement apparatus so as to be able to capture an image of the reference face;

(b) a step of calculating an amount of movement of the measurement apparatus relative to the reference face, based on the displacement and preset imaging information regarding the imaging apparatus; and

(c) a step of correcting vibrations measured by the measurement apparatus, so as to be vibrations relative to the reference face, using the amount of movement.

Furthermore, to achieve the object described above, a computer-readable recording medium according to one aspect of the invention is a computer-readable recording medium having recorded thereon a program for correcting a result of measurement performed by a measurement apparatus that measures vibrations of an object, using a computer,

the program including instructions that cause the computer to carry out:

(a) a step of calculating a displacement of a preset reference face based on time-series images of the reference face output from an imaging apparatus that is fixed to the measurement apparatus so as to be able to capture an image of the reference face;

(b) a step of calculating an amount of movement of the measurement apparatus relative to the reference face, based on the displacement and preset imaging information regarding the imaging apparatus; and

(c) a step of correcting vibrations measured by the measurement apparatus, so as to be vibrations relative to the reference face, using the amount of movement.

### Advantageous Effects of the Invention

As described above, according to the invention, it is possible to accurately measure vibrations of an object even if the measurement apparatus that measures vibrations of the object is installed in a location that is likely to be vibrated.

### BRIEF DESCRIPTION OF THE DRAWINGS

FIG. 1 is a block diagram showing overall configurations of a measurement system and a correction processing apparatus according to an example embodiment of the invention.

FIG. 2 is a block diagram specifically showing configurations of a measurement system and a correction processing apparatus according to a first example embodiment of the invention.

FIG. 3 is a flowchart showing operations of the measurement system and the correction processing apparatus according to the first example embodiment of the invention.

FIG. 4 is a diagram for illustrating components of displacement that is observed on processing images when images of a reference face are captured.

FIG. 5 is a diagram showing a two-dimensional spatial distribution of displacement vectors (δxᵢⱼ,δyᵢⱼ) that are observed on images of the reference face.

FIG. 6 is a block diagram showing overall configurations of a measurement system and a correction processing apparatus according to a second example embodiment of the invention.

FIG. 7 is a diagram showing a positional relationship between the measurement apparatus and the imaging apparatus shown in FIG. 8, viewed from a different angle.

FIG. 8 is a block diagram specifically showing configurations of the measurement system and the correction processing apparatus according to the second example embodiment of the invention.

FIG. 9 is a flowchart showing operations of the measurement system and the correction processing apparatus according to the second example embodiment of the invention.

FIG. 10 is a block diagram showing an example of a computer that realizes the correction processing apparatuses according to the first or second example embodiment.

### EXAMPLE EMBODIMENTS

### First Example Embodiment

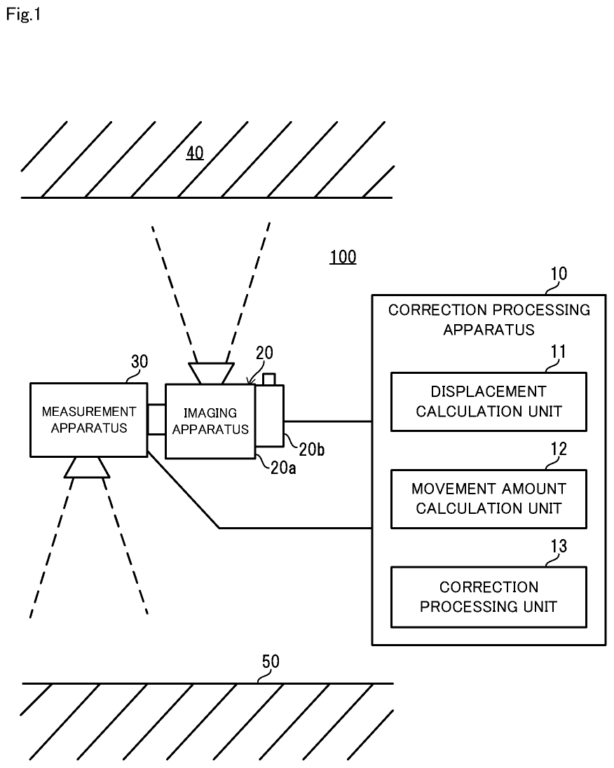

The following describes a measurement system, a correction processing apparatus, a correction processing method, and a program according to a first example embodiment of the invention with reference to FIGS. 1 to 5.

Apparatus Configuration

First, configurations of a measurement system and a correction processing apparatus according to the first example embodiment will be described with reference to FIG. 1. FIG. 1 is a block diagram showing overall configurations of the measurement system and the correction processing apparatus according to an example embodiment of the invention.

A measurement system 100 according to the first example embodiment shown in FIG. 1 is a system for measuring vibrations of an object 40. In this example embodiment, the object 40 is, for example, an infrastructural component such as a bridge, a road, a building, or a facility.

As shown in FIG. 1, the measurement system 100 includes a measurement apparatus 20, an imaging apparatus 30, and a correction processing apparatus 10. Among these apparatuses, the measurement apparatus 20 is an apparatus that measures vibrations of the object 40 in specific directions. The imaging apparatus 30 is an apparatus that captures images of a reference face 50 that has been set in advance. The imaging apparatus 30 is fixed to the measurement apparatus 20 so as to be able to capture an image of the reference face 50.

The correction processing apparatus 10 is an apparatus that corrects the vibrations measured by the measurement apparatus 20. As shown in FIG. 1, the correction processing apparatus 10 includes a displacement calculation unit 11, a movement amount calculation unit 12, and a correction processing unit 13.

The displacement calculation unit 11 calculates a displacement of the reference face 50 from time-series images of the reference face 50 output from the imaging apparatus 30. The movement amount calculation unit 12 calculates the amount of movement of the measurement apparatus 20 relative to the reference face 50 based on the calculated displacement and imaging information regarding the imaging apparatus 30, which has been set in advance. Using the calculated amount of movement, the correction processing unit 13 corrects the vibrations measured by the measurement apparatus 20, so as to be vibrations relative to the reference face 50.

In this way, according to the first example embodiment, the value of vibrations measured by the measurement apparatus 20 is corrected so as to be a value obtained with reference to the reference face. Therefore, even if the measurement apparatus 20 is installed in a location that is likely to be vibrated, it is possible to accurately measure vibrations of the object 40.

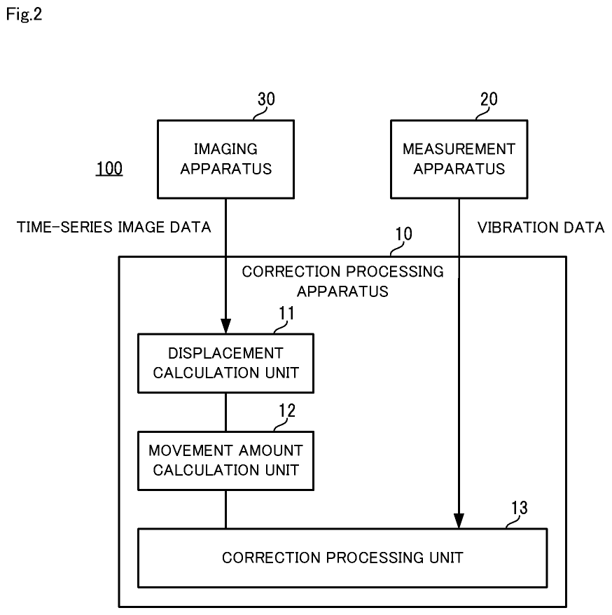

Next, the configurations of the measurement system and the correction processing apparatus according to the first example embodiment will be more specifically described with reference to FIG. 2 in addition to FIG. 1. FIG. 2 is a block diagram specifically showing configurations of the measurement system and the correction processing apparatus according to the first example embodiment of the invention.

First, in the first example embodiment, the object 40 is a bridge, and the measurement apparatus 20 measures vibrations in a predetermined area (hereinafter denoted as a “measurement target area”) of the lower surface of the superstructure of the bridge, such as the girder or the slab. The directions of vibrations that are to be measured by the measurement apparatus 20 are set to be three directions, namely two directions that are orthogonal to each other on the measurement target area, and a direction (a normal direction) that is orthogonal to the measurement target area.

In the first example embodiment, the measurement apparatus 20 includes an imaging device 20a that captures images of the measurement target area and a distance meter 20b that measures a distance from the measurement apparatus 20 to the measurement target area. The measurement apparatus 20 measures vibrations in the two directions that are orthogonal to each other on the measurement target area, based on images output from the imaging device 20a thereof, and measures vibrations in the normal direction of the measurement target area, based on the distance measured by the distance meter 20b. The measurement apparatus 20 also inputs vibration data that specifies the measured vibrations in the three directions, to the correction processing apparatus 10. Note that, in the first example embodiment, the configuration of the measurement apparatus 20 is not limited to the configuration shown in FIG. 2. The measurement apparatus 20 may also only include the imaging device 20a. In such a case, the measurement apparatus 20 specifies vibrations in the three directions based on images captured by the imaging device 20a.

The reference face 50 need only be set to a location that will not be affected or is unlikely to be affected by vibrations of the object 40, e.g. the foundation of the substructure of the bridge, such as the ground or the pier of the bridge. In the first example embodiment, the reference face 50 is set to a face that is parallel with the measurement target area.

In the imaging apparatus 30 in the first example embodiment, the normal of the light-receiving surface of the solid-state imaging sensor thereof is parallel with the normal of the reference face, and the imaging apparatus 30 is attached to the measurement apparatus 20 such that the horizontal direction and the vertical direction of time-series images respectively coincide with the horizontal direction and the vertical direction of images captured by the imaging device 20a of the measurement apparatus 20. Therefore, in the first example embodiment, the two directions that are orthogonal to each other on the measurement target area correspond to the two directions (the X and Y directions) that are orthogonal to each other on time-series images (the reference face 50), and the normal direction of the measurement target area corresponds to the normal direction (the Z direction) of the reference face 50.

Here, in order to accurately measure vibrations of the object, it is desirable that the measurement apparatus 20 is located close to the object 40. Therefore, the measurement apparatus 20 may be installed to, for example, an inspection passage or scaffold provided in an infrastructural component such as a bridge. On the other hand, in terms of the accuracy of measurement values, it is preferable that the measurement apparatus 20 is installed in a location where is not to be affected by vibrations of the object 40. However, an inspection passage and scaffold are often attached to the infrastructural component, which is the object 40, and are generally likely to be affected by vibrations. Therefore, if the object 40 vibrates, the inspection passage and scaffold to which the measurement apparatus 20 is installed are also affected and vibrated, and accordingly the measurement apparatus 20 is also affected and vibrated. Also, the imaging apparatus 30 is fixed to the measurement apparatus 20, and therefore the imaging apparatus 30 is also vibrated in such a case. However, in the first example embodiment, the amounts of movement of the measurement apparatus 20 and the imaging apparatus 30 relative to the reference face 50 are calculated by the correction processing apparatus 10, and correction is performed using the amounts. Therefore, vibrations of the measurement apparatus 20 are canceled out.

In the correction processing apparatus 10 in the first example embodiment, the displacement calculation unit 11 acquires time-series images output from the imaging apparatus 30, and determines an image captured at a given point in time as a reference image, and determines the other images as processing images. Thereafter, the displacement calculation unit 11 calculates a displacement relative to at least one specific area (hereinafter denoted as a “specific area”) of the reference image for each processing image.

Specifically, the displacement calculation unit 11 first compares the specific areas of each processing image with the specific areas of the reference image, specifies the specific area with the highest matching level for each processing image, and calculates displacements (d1x, d1y) of the specific area. A method for finding the specific area with the highest matching level is, for example, a method utilizing a similarity correlation function such as the SAD (Sum of Squared Difference), the SSD (Sum of Absolute Difference), the NCC (Normalized Cross-Correlation), the ZNCC (Zero-means Normalized Cross-Correlation) to find the position (the coordinate point) with the highest correlation level.

Also, in order to specify the position of the specific area with the highest matching level, the position (the coordinate point) of the specific area with the highest matching level and a similarity correlation function regarding areas at front, rear, left, and right positions (the coordinate points) relative to the position (the coordinate point) may be utilized, and a method such as linear fitting, curve fitting, or parabolic fitting may be employed, using the calculated similarity correlation function. As a result, it is possible to more accurately calculate the position (the coordinate position) of an area with a high degree of similarity on the order of sub-pixels.

Next, in order to calculate a displacement d1z of the specific area in the normal direction, the displacement calculation unit 11 creates images (hereinafter denoted as a “set of reference images”) by enlarging and reducing the reference image at predetermined magnifications. At this time, the displacement calculation unit 11 sets the central positions of the enlarged images and the reduced images created from the reference image, based on the previously calculated displacements (d1x, d1y), to create a set of reference images.

Next, the displacement calculation unit 11 compares each processing image with the enlarged images and the reduced images that constitute the set of reference images, to specify enlarged images and reduced images with the highest matching level. Images with the high matching level can be specified by, for example, using any of the similarity correlation functions described above, such as the SAD, the SSD, the NCC, and the ZNCC. Thereafter, the displacement calculation unit 11 specifies the image with the highest degree of similarity from among the images constituting the set of reference images, i.e. the image with the highest matching level, and calculates the enlargement ratio or the reduction ratio (hereinafter denoted as a “magnification”) of the specified image as an amount (d1z) that indicates the displacement of the specific area in the normal direction.

Also, after specifying the image with the highest matching level, the displacement calculation unit 11 may select images before and after the specified image in order of magnifications, from among the set of reference images, calculate the similarity correlation function of the specified image and the selected image, and calculate a magnification as the amount (d1z) indicating the displacement in the normal direction, using the calculated similarity correlation function and employing a method such as linear fitting, curve fitting, or the like. As a result, it is possible to more accurately calculate the magnification (d1z) as an amount that indicates the displacement in the normal direction. Thus, the displacement calculation unit 11 calculates the displacements (d1x, d1y) and the magnification (d1z) as an amount that indicates the displacement in the normal direction for each processing image.

Also, in order to improve the accuracy of the displacement, the displacement calculation unit 11 may perform the above-described processing multiple times. Specifically, the displacement calculation unit 11 selects an image corresponding to the magnification d1z from among the images constituting the set of reference images, considering the influence of the previously calculated magnification d1z, and determines the selected image as a new reference image. Next, the displacement calculation unit 11 compares a processing image with a specific area of the new reference image to specify the area that is the most similar to the specific area of the new reference image from the processing image, calculates the position of the area, and detects displacements (d2x, d2y) of the specific area.

Next, the displacement calculation unit 11 sets the central position of enlargement or reduction for each of the images constituting the set of reference images, based on the newly detected displacements (d2x, d2y), to create a new set of reference images. Thereafter, the displacement calculation unit 11 calculates the degree of similarity between an area corresponding to the specific area of the processing image and the specific area of each of the images constituting the new set of reference images, and specifies the image with the highest degree of similarity from among the images constituting the new set of reference images. Thereafter, the displacement calculation unit 11 calculates the magnification of the specified image as an amount (d2z) that indicates the displacement of the specific area in the normal direction.

In this way, in the first processing, the displacements (d1x, d1y) are calculated without considering d1z, which is the magnification indicating the displacement in the normal direction, whereas, in the second processing, the displacements (d2x, d2y) are calculated considering the magnification d1z. Therefore, the calculation accuracy of the displacements (d2x, d2y) calculated through the second processing are improved. Also, if similar processing is performed multiple times, the accuracy of the displacement is further improved.

Although the processing in the above-described example is repeated twice, the number of repetitions is not particularly limited. The number of repetitions may be a preset number, or set as appropriate according to the result. Also, the processing may be repeated until the value of the calculated displacement reaches a threshold value.

In the following description, the displacements that are ultimately obtained for a given processing image are denoted as displacements (dnx, dny), and the amount indicating the displacement in the normal direction is denoted as a magnification (dnz). The results of similar calculation of the displacements for the time-series images can be regarded as values that change over time, and therefore they are denoted as displacements (dnx(t), dny(t)) and a magnification (dnz(t)).

The movement amount calculation unit 12 calculates the amount of movement of the imaging apparatus 30 relative to the reference face 50 based on the displacements (dnx(t), dny(t)) and the magnification (dnz(t)) of the imaging apparatus 30 relative to the reference face 50 calculated from the time-series images, obtained by the displacement calculation unit 11, and imaging information regarding the imaging apparatus 30. Imaging information regarding the imaging apparatus 30 includes at least the size of each pixel of the solid-state imaging device, the focal distance of the lens, the distance from the principal point of the lens to the reference face 50, and the shooting frame rate.

The amount of movement in a direction that is parallel with the reference face 50 of the imaging apparatus 30 thus obtained can be calculated from the displacements (dnx(t), dny(t)). Also, the amount of movement in a direction that is orthogonal to the reference face 50 (the normal direction) can be calculated from the magnification (dnz(t)). The amounts of movement are obtained for each of the shooting frame rates used to capture the time-series images. Therefore, each amount of movement can be regarded as vibration information obtained at sampling intervals that are equal to the inverse of the shooting frame rate.

The correction processing unit 13 corrects vibrations so as to be vibrations of the object 40 relative to the reference face 50, using the vibrations of the object 40 measured by the measurement apparatus 20 and the amount of movement of the imaging apparatus 30 calculated by the movement amount calculation unit 12 relative to the reference face 50.

Note that a location that is unlikely to be affected by vibrations of the object 40 is selected as the reference face 50, and the amount of movement of the reference face 50 itself is far smaller than the amount of movement of the object 40. Therefore, if it is assumed that the amount of movement of the reference face 50 is zero, the amount of movement and vibrations of the object 40 relative to the reference face 50 can be substantially obtained as the amount of movement and vibrations of the object 40 itself.

If the frequency of the vibrations of the object 40 is different from the frequency of the vibrations of the measurement apparatus 20, the imaging apparatus 30, or the reference face 50, filtering processing may also be performed using a low-pass filter, a high-pass filter, a band-pass filter, a notch filter, or the like. As a result, corresponding processing can be more effectively performed on the vibrations measured by the measurement apparatus 20.

Apparatus Operations

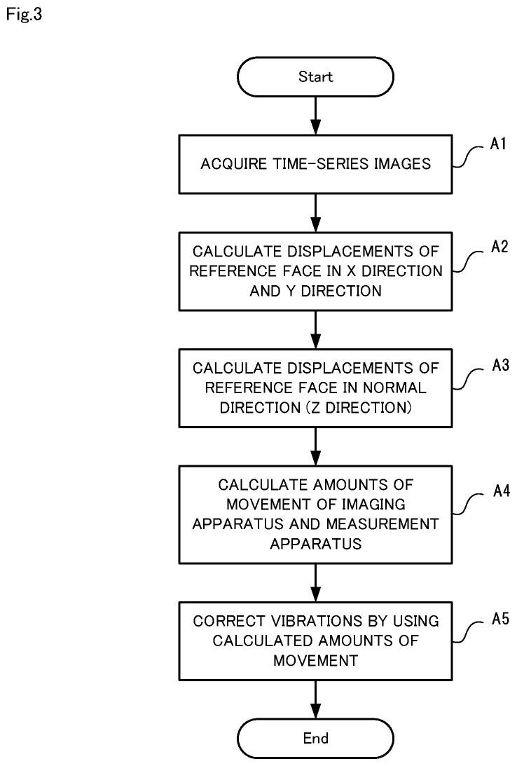

Next, operations of the measurement system 100 and the correction processing apparatus 10 according to the first example embodiment of the invention will be described with reference to FIG. 3. FIG. 3 is a flowchart showing operations of the measurement system and the correction processing apparatus according to the first example embodiment of the invention. In the following description, FIGS. 1 and 2 will be referenced as appropriate. Also, in the first example embodiment, a correction processing method is performed by operating the correction processing apparatus 10. Therefore, the following description of operations of the correction processing apparatus 10 substitutes for a description of a correction processing method according to the first example embodiment.

As shown in FIG. 3, first, the displacement calculation unit 11 in the correction processing apparatus 10 acquires the image data of time-series images output from the imaging apparatus 30 (step A1). Specifically, the imaging apparatus 30 outputs pieces of image data at a preset frame rate, and therefore the displacement calculation unit 11 acquires the image data of time-series images until a predetermined period is reached or a predetermined number of frames is reached.

Next, the displacement calculation unit 11 determines one image captured at a given point in time, from among the acquired time-series images, as a reference image, determines the other images as processing images, and compares them with each other to calculate the displacement of the reference face 50 in the horizontal direction (the X direction) of the images and the displacement of the reference face 50 in the vertical direction (the Y direction) of the images (step A2). Note that the displacements calculated at this time are equivalent to the displacements of the imaging apparatus 30 in the horizontal direction and the vertical direction of the images relative to the reference face 50 because the reference face 50 does not move.

Specifically, in step A2, as described above, the displacement calculation unit 11 compares the specific areas of the processing images and the specific area of the reference image with each other, and specifies the position of the specific area with the highest matching level. A method for finding the specific area with the highest matching level is, for example, a method utilizing a similarity correlation function such as the SAD (Sum of Squared Difference), the SSD (Sum of Absolute Difference), the NCC (Normalized Cross-Correlation), the ZNCC (Zero-means Normalized Cross-Correlation) to find the position (the coordinate point) with the highest correlation level.

Also, in order to improve the accuracy of calculation, the displacement calculation unit 11 may use a similarity correlation function regarding areas at front, rear, left, and right positions relative to the position of the specific area with the highest matching level, and employ a method such as linear fitting, curve fitting, or parabolic fitting, as appropriate. The positions thus obtained are calculated as the displacements (d1x, d1y) of the imaging apparatus 30 relative to the reference face 50, corresponding to the horizontal direction and the vertical direction of the images.

Next, using the processing images, the reference image, and the displacements (d1x, d1y) of the reference face 50 calculated in step A2, the displacement calculation unit 11 calculates the magnification d1z indicating the displacement of the reference face 50 in the normal direction (the Z direction) (step A3). Note that the magnification d1z calculated here indicates the displacement of the imaging apparatus 30 in the normal direction of the reference face 50, because the reference face 50 does not actually move.

Specifically, in step A3, as described above, the displacement calculation unit 11 creates a set of reference images by enlarging and reducing the reference image at predetermined magnifications. Also, the displacement calculation unit 11 compares each processing image with the enlarged images and the reduced images that constitute the set of reference images, to specify images with the highest matching level. Here, images with the high matching level can be specified by, for example, using any of the similarity correlation functions described above, such as the SAD, the SSD, the NCC, and the ZNCC.

Thereafter, the displacement calculation unit 11 specifies the image with the highest matching level, i.e. the image with the highest correlation level, from among the images constituting the set of reference images, and calculates the enlargement ratio or the reduction ratio of the specified image as the magnification (d1z) indicating the displacement of the specific area in the normal direction.

Furthermore, as necessary, the displacement calculation unit 11 may calculate the similarity correlation functions of images before and after the image with the highest matching level, in order of magnifications, and accurately calculate the magnification by using them and employing a method such as linear fitting, curve fitting, or the like. As a result of this processing, the magnification is calculated as the magnification (d1z) indicating the displacement of the specific area of the surface of the imaging apparatus 30 in the normal direction relative to the reference face 50. Also, the processing in steps A2 and A3 may be repeatedly performed two or more times.

Next, the movement amount calculation unit 12 calculates the actual amounts of movement of the imaging apparatus 30 and the measurement apparatus 20, using the displacements (d1x, d1y) in the horizontal direction and the vertical direction calculated in step A2, the magnification d1z calculated in step A3, and imaging information regarding the imaging apparatus 30 (step A4).

Specifically, the size of one pixel (the pitch per pixel) of the solid-state imaging sensor of the imaging apparatus 30 is denoted as d (mm), the focal distance of the lens is denoted as f (mm), the distance from the principal point of the lens to the reference face 50 is denoted as L (mm), and the shooting frame rate is denoted as FPS (fps). In this case, the size D (mm/pixel) of one pixel of an image of the reference face 50 is calculated according to Math. 1 shown below.

D=d×(L/f) [Math. 1]

Here, it is assumed that the displacements calculated in step A2 are dnx (pixel) and dny (pixel), and the magnification calculated in step A3 is dnz (magnification). In this case, the movement amount calculation unit 12 calculates the actual amounts of movement (mm) of the imaging apparatus 30 relative to the reference face 50 according to Math. 2 to Math. 4 shown below. Here, the moving direction of the imaging apparatus 30 corresponding to the horizontal direction of the time-series images is referred to as an “in-plane horizontal direction”, and the moving direction of the imaging apparatus 30 corresponding to the vertical direction of the time-series images is referred to as an “in-plane vertical direction”.

The actual amount of movement (mm) of the imaging apparatus in the in-plane horizontal direction relative to the reference face=dnx×D [Math. 2]

The actual amount of movement (mm) of the imaging apparatus in the in-plane vertical direction relative to the reference face=dny×D [Math. 3]

The actual amount of movement (mm) of the imaging apparatus in the normal direction relative to the reference face=(1/dnz−1)×L [Math. 4]

Also, when the amounts of movement are calculated for the displacements and the magnification calculated from the time-series images, data regarding the amounts of movement can be obtained at time intervals that are equal to the inverse of the shooting frame rate (1/FPS). Therefore, the data thus obtained can be regarded as vibration information obtained at sampling intervals that are equal to the inverse of the shooting frame rate.

Next, using the amounts of movement obtained in step A4, the correction processing unit 13 corrects vibrations specified by the vibration data acquired from the measurement apparatus 20 so as to be vibrations of the object 40 relative to the reference face 50 (step A5). Also, the correction processing unit 13 outputs data that specifies the corrected vibrations.

Specifically, the correction processing unit 13 acquires vibration data from the measurement apparatus 20, and specifies the amount of movement of the measurement target area relative to the measurement apparatus 20, from the acquired vibration data. Thereafter, the correction processing unit 13 calculates vibrations of the object 40 relative to the reference face 50 by subtracting the amount of movement (a second amount of movement) of the imaging apparatus 30 relative to the reference face 50, calculated in step A4, from the specified amount of movement.

In this way, according to the first example embodiment, the value of vibrations measured by the measurement apparatus 20 is corrected so as to be a value relative to the reference face 50. Therefore, if the reference face 50 is a face that is unlikely to be affected by vibrations of the object 40, it is possible to accurately measure vibrations of the object 40 even if the measurement apparatus 20 is installed in a location that is likely to be vibrated. Although vibrations are corrected in three directions in the first example embodiment, the present invention is not limited in this way, and vibrations may be corrected in only one direction.

Program

A program according to the first example embodiment need only be a program that causes a computer to execute steps A1 to A5 shown in FIG. 3. The correction processing apparatus 10 and the correction processing method according to this example embodiment can be realized by installing this program to a computer and executing the program. In this case, a CPU (Central Processing Unit) of the computer functions as the displacement calculation unit 11, the movement amount calculation unit 12, and the correction processing unit 13, and performs processing.

The program according to the first example embodiment may be executed by a computer system that is established from a plurality of computers. In this case, for example, each computer may function as one of the displacement calculation unit 11, the movement amount calculation unit 12, and the correction processing unit 13.

Modification

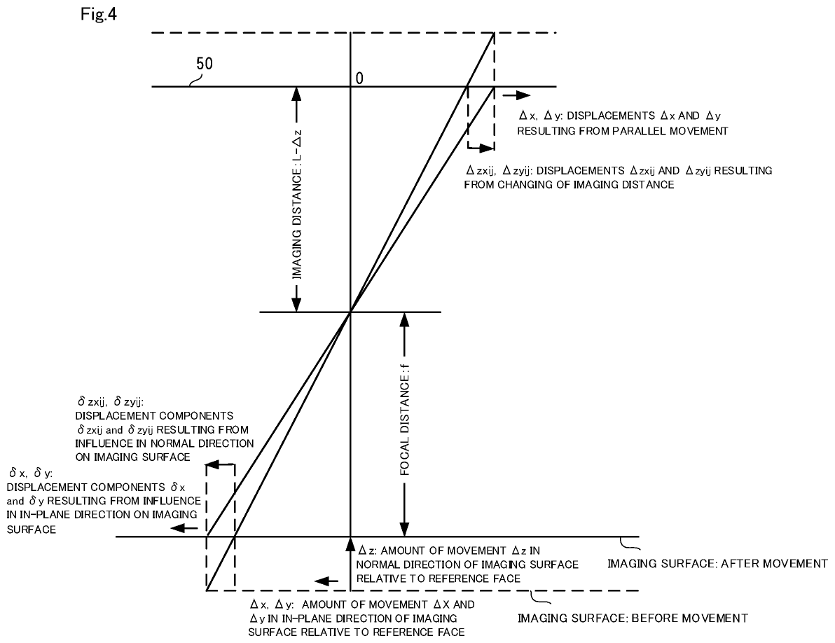

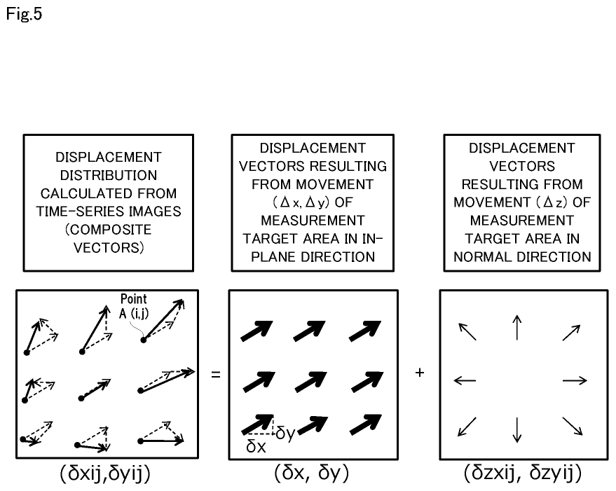

Hereinafter, a modification of the first example embodiment will be described with reference to FIGS. 4 and 5. In the modification, processing that is performed to calculate a displacement and processing that is performed to calculate the amounts of movement are different from those in the first example embodiment. FIG. 4 is a diagram showing a displacement of an image in the time-series images relative to the reference face, caused by vibrations of the imaging apparatus.

It is assumed here that the reference face 50 is fixed and the measurement apparatus 20 and the imaging apparatus 30 are vibrated in three-dimensional directions. For example, the amounts of movement in the horizontal direction, the vertical direction (the X direction and the Y direction) relative to the reference face 50 of the imaging apparatus 30 and the amount of movement in the normal direction (the X direction) of the reference face 50 corresponding to the screen at a given point in time are respectively denoted as Δx, Δy, and Δz.

A displacement (δxᵢⱼ,δyᵢⱼ) observed at a point A represented by coordinates (i,j) in a coordinate system with the origin at the imaging center of the screen is examined below. When the imaging apparatus 30 is moved in the normal direction of the reference face 50 by an amount of movement Δz, the imaging distance is reduced by Δz. As a result, as shown in FIG. 4, a displacement δzxᵢ is caused on the imaging surface of the imaging apparatus 30 due to an amount of movement Δz, separately from a displacement δx that is caused due to an amount of movement Δx of the imaging apparatus 30 in the horizontal direction (the X direction) relative to the screen. Similarly, a displacement δzyⱼ is caused on the imaging surface of the imaging apparatus 30 due to an amount of movement Δz, separately from a displacement δy that is caused due to an amount of movement Δy of the imaging apparatus 30 in the vertical direction (the Y direction) relative to the screen. Also, at this time, if the surface of the reference face 50 is deformed or displaced, a surface displacement component (δδxᵢⱼ,δδyᵢⱼ) accordingly generated are also superimposed to the displacement.

Therefore, the displacement (δxᵢⱼ,δyᵢⱼ) that is observed at the point A can be represented by Math. 5 and Math. 6 shown below, as shown in FIG. 5.

$$\begin{matrix}( δ {x}_{ij} , {dy}_{ij} ) = [ Displacement components ( \partial x , \partial y ) resulting from the movement ( Δ x , Δ y ) in the in \text{-} plane direction ] + [ Displacement components nen ( δ {zx}_{ij} , δ {zy}_{ij} ) resulting from the movement ( Δ z ) in the normal direction ] + [ Surface displacement components ( δδ xij , δδ yij ) ] & [ Math . 5 ] \\ ( δ {x}_{ij} , δ {y}_{ij} ) = ( δ x + {dzx}_{ij} + {δδx}_{ij} , δ y + δ {zy}_{ij} + δδ {y}_{ij} ) & [ Math . 6 ]\end{matrix}$$

Here, when the imaging distance from the principal point of the lens to the reference face 50 is denoted as L, the focal distance of the lens of the imaging apparatus 30 is denoted as f, and a coordinate point relative to the imaging center is denoted as (i,j), the displacement components (δx,δy) resulting from the movement (Δx,Δy) in the in-plane direction, the displacement components (δzxᵢⱼ,δzyᵢⱼ) resulting from the movement (Δz) in the normal direction, and the surface displacement components (δδxᵢⱼ,δδyᵢⱼ) are respectively represented by Math. 7, Math. 8, and Math. 9 below. Note that the reference face 50 selected this time is a face on which the surface is unlikely to be deformed or displaced, and the surface displacement components (δδxᵢⱼ,δδyᵢⱼ) can be regarded as zero.

$$\begin{matrix}( δ x , δ y ) = ( \frac{f}{L - Δ z} Δ x , \frac{f}{L - Δ z} Δ y ) & [ Math . 7 ] \\ ( δ z {x}_{ij} , δ {zy}_{ij} ) = ( f ( \frac{1}{L - Δ z} - \frac{1}{L} ) i , f ( \frac{1}{L - Δ z} - \frac{1}{L} ) j ) & [ Math . 8 ] \\ ( δδ {x}_{y} , δδ {y}_{ij} ) = ( 0 , 0 ) & [ Math . 9 ]\end{matrix}$$

FIG. 4 is a diagram for illustrating the components of displacement that is observed on processing images when images of the reference face are captured. Specifically, in FIG. 4, regarding the imaging apparatus 30, amounts of movement (Δx, Δy, and Δz) are generated in the horizontal direction and the vertical direction on the screen (the X and Y directions) relative to the reference face 50, and in the normal direction of the reference face 50 (the Z direction). In this case, the relationship between the displacement components (δx,δy) resulting from the movement (Δx,Δy) in the in-plane direction and the displacement components (δzxᵢⱼ,δzyᵢⱼ) resulting from the movement (Δz) in the normal direction indicated by the above Math. 7 and Math. 8 is as shown in FIG. 4.

As shown in FIG. 4, the displacement of the reference face can be represented as a composite vector of the displacement components (δx,δy) resulting from the movement (Δx,Δy) in the in-plane direction, which can be observed in a uniform direction with a uniform size in the entire screen, displacement components (δzxᵢⱼ,δzyᵢⱼ) resulting from the movement (Δz) in the normal direction, which can be observed as vectors that radially extend from the imaging center of the screen, and surface displacement components (δδxᵢⱼ,δδyᵢⱼ) resulting from a deformation or a displacement of the surface of the reference face.

FIG. 5 is a diagram showing a two-dimensional spatial distribution of displacement vectors (δxij,δyij) that are observed on images of the reference face (hereinafter referred to as a displacement distribution). As shown in FIG. 5, the displacement vectors (δxᵢⱼ,δyᵢⱼ) are each observed as a composite vector of the displacement vector components (δx,δy) resulting from the movement (Δx,Δy) in the in-plane direction, the displacement vector components (δzxᵢⱼ,δzyᵢⱼ) resulting from the movement (Δz) in the normal direction, and the surface displacement components (δδxᵢⱼ,δδyᵢⱼ).

Also, as shown in FIG. 5, the displacement components (δx,δy) resulting from the movement (Δx,Δy) in the in-plane direction can basically be observed in a uniform direction with a uniform size with a uniform size in the entire screen, like offsets. The displacement components (δzxᵢⱼ,δzyᵢⱼ) resulting from the movement (Δz) in the normal direction are generated as enlargement or reduction within the screen when the measurement target moves in the normal direction. Therefore, characteristic displacement vectors that extend in radial directions occur in the two-dimensional spatial displacement distribution. The surface displacement components (δδxᵢⱼ,δδyᵢⱼ) are zero because the shooting target is the reference face this time, and a location where the surface is unlikely to be deformed or displaced has been selected as the reference face.

Here, a method for calculating the displacement vector components (δx,δy) resulting from the movement (Δx,Δy) in an in-plane direction will be examined. First, a displacement is analyzed using the above-described method, for each pixel in a certain area centered around the imaging center of the screen, and a displacement distribution is calculated as shown in FIG. 5. Thereafter, all of the respective displacement vectors of the pixels thus calculated are added up, and an average is calculated. Thus, the displacement vector components (δx,δy) resulting from the movement (Δx,Δy) in the in-plane direction can be calculated.

The following describes the details of this method. First, as shown in FIG. 5, composite vectors of displacement vector components (δx,δy) resulting from the movement (Δx,Δy) in the in-plane direction and the displacement vector components (δzxᵢⱼ,δzyᵢⱼ) resulting from the movement (Δz) in the normal direction are observed in the displacement distribution. Here, as shown in FIG. 5, in an area centered around the imaging center of the screen, the displacement vector components (δzxᵢⱼ,δzyᵢⱼ) resulting from the movement (Δz) in the normal direction are observed as radial vectors.

Therefore, the displacement vector components (δzxᵢⱼ,δzyᵢⱼ), which are radial displacement vector components and are generated as a result of the movement (Δz) in the normal direction, can be canceled out by adding up all of the respective displacement vectors of the pixels in the area centered around the imaging center of the screen. As a result, only the components obtained by adding up the displacement vector components (δx,δy) resulting from the movement (Δx,Δy) in an in-plane direction remain. Therefore, it is possible to calculate the displacement vector components (δx,δy) resulting from the movement (Δx,Δy) in the in-plane direction by calculating the average of the values of the remaining components. That is to say, through the above-described method, it is possible to calculate the displacement vector components (δx,δy) resulting from the movement (Δx,Δy) in the in-plane direction.

Next, a method for calculating the displacement vector components (δzxᵢⱼ,δzyᵢⱼ) resulting from the movement (Δz) in the normal direction will be examined. When only the displacement vector components (δzxᵢⱼ,δzyᵢⱼ) resulting from the movement (Δz) in the normal direction are considered, the magnitude R(i,j) of the vector is proportional to the distance from the imaging center if the amount of movement Δz is constant, as indicated by Math. 10 below. When the constant of proportionality is denoted as k as shown in Math. 11 below, Math. 10 shown below can also be represented as Math. 12 shown below.

$$\begin{matrix}R ( i , j ) = \sqrt{δ {zx}_{ij}^{2} + δ {zy}_{ij}^{2}} = f ( \frac{1}{L - Δ z} - \frac{1}{L} ) \sqrt{{i}^{2} + {j}^{2}} & [ Math . 10 ] \\ k = f ( \frac{1}{L - Δ z} - \frac{1}{L} ) & [ Math . 11 ] \\ R ( i , j ) = k \sqrt{{i}^{2} + {j}^{2}} & [ Math . 12 ]\end{matrix}$$

Also, as can be seen from FIG. 5, the displacement distribution that is actually measured through image processing is that of composite vectors V(vi,vj) of the displacement vector components (δzxᵢⱼ,δzyᵢⱼ) resulting from the movement (Δz) in the normal direction (the thin solid arrows in FIGS. 4 and 5) and the displacement vector components (δx,δy) resulting from the movement (Δx,Δy) in the in-plane direction (the thick solid arrows in FIGS. 4 and 5).

Displacement vector components obtained by subtracting the displacement vector components (δx,δy) resulting from the movement (Δx,Δy) in the in-plane direction calculated above, from the composite vectors V(vi,vj) are the displacement vector components (δzxᵢⱼ,δzyᵢⱼ) resulting from the movement (Δz) in the normal direction. Therefore, when the displacement vector components (δzxᵢⱼ,δzyᵢⱼ) resulting from the movement (Δz) in the normal direction at a given coordinate point (i,j) are denoted as Rmes(i,j), they can be represented by Math. 13 and Math. 14 shown below. In a modification of the first example embodiment, the displacement calculation unit 11 calculates Rmes(i,j) shown in Math. 13 below and a measurement vector V(vi,vj) shown in Math. 13 below, as the displacement distribution.

Rₘₑₛ(i,j)=\sqrt{(vi−δx)²+(vj−δy)²} [Math. 13]

If the amount of movement Δz increases, the magnitude R(i,j) of the displacement vector components (δzxᵢⱼ,δzyᵢⱼ) resulting from the movement (Δz) in the normal direction also increases. The magnification of R(i,j) is equal to the constant of proportionality k given in Math. 11 shown above.

Also, Rmes(i,j) obtained by subtracting the displacement vector components (δx,δy) resulting from the movement (Δx,Δy) in the in-plane direction from the measurement vector V(vi,vj) in advance changes along with the movement (Δz) in the normal direction in a similar manner as the magnitude R(i,j) of the displacement vector components (δzxᵢⱼ,δzyᵢⱼ) resulting from the movement (Δz) in the normal direction.

Therefore, it is possible to estimate the magnification of R(i,j) from Rmes(i,j). Specifically, it is possible to estimate the magnification of R(i,j) by calculating the constant of proportionality k that minimizes an evaluation function E(k) shown in Math. 14 below.

$$E ( k ) = {\sum }_{i , j} {\{ \text{?} ( i , j ) - R ( i , j , k ) \}}^{2} \\ \text{?} \text{indicates text missing or illegible when filed} \qquad [ Math . 14 ]$$

Therefore, in a modification of the example embodiment, the movement amount calculation unit 12 calculates the constant of proportionality k by applying the method of least squares to Math. 14 shown above. In addition to the sum of squares of the difference between Rmes(i, j) and R(i, j) in Math. 16 shown above, the sum of absolute values, the sum of other kind of repeated multiplication, or the like may be used as the evaluation function E(k).

Thereafter, the movement amount calculation unit 12 calculates the amount of movement Δz by applying the calculated enlargement coefficient k to Math. 14 shown above. Also, the movement amount calculation unit 12 substitutes the calculated amount of movement Δz into Math. 8 shown above to calculate the displacement vector components (δzxᵢⱼ,δzyᵢⱼ) resulting from the movement (Δz) in the normal direction. Furthermore, the movement amount calculation unit 12 calculates the displacement vector components (δx,δy) resulting from the movement (Δx,Δy) in the in-plane direction, by subtracting the displacement vector components (δzxᵢⱼ,δzyᵢⱼ) resulting from the calculated movement (Δz) in the normal direction, from the measurement vector V(vi,vj) calculated by the displacement calculation unit 11 (see Math. 5 and Math. 6 shown above).

Thereafter, the movement amount calculation unit 12 calculates the amounts of movement Δx and Δy of the imaging apparatus by applying the calculated displacement vector components (δx,δy) resulting from the movement (Δx,Δy) in the in-plane direction and the amount of movement Δz to Math. 7 shown above. Δx, Δy, and Δz thus calculated are the amounts of movement of the imaging apparatus 30 in three directions, relative to the reference face 50.

### Second Example Embodiment

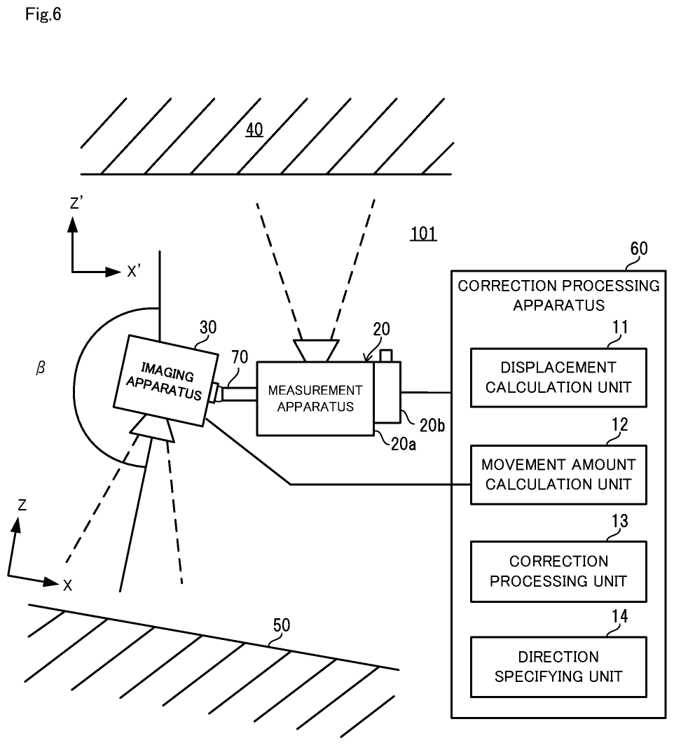

Next, a measurement system, a correction processing apparatus, a correction processing method, and a program according to a second example embodiment of the invention will be described with reference to FIGS. 6 to 9.

Apparatus Configuration

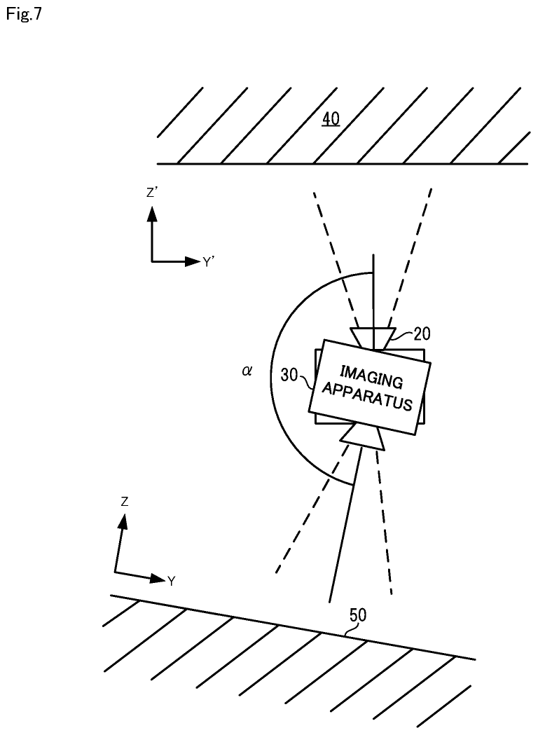

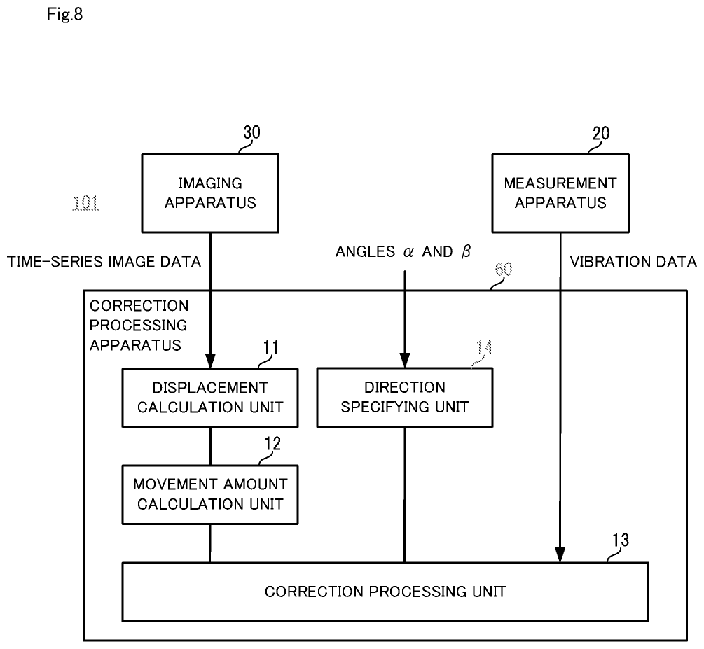

First, configurations of a measurement system and a correction processing apparatus according to the second example embodiment will be described with reference to FIGS. 6 to 8. FIG. 6 is a block diagram showing overall configurations of the measurement system and the correction processing apparatus according to the second example embodiment of the invention. FIG. 7 is a diagram showing a positional relationship between the measurement apparatus and the imaging apparatus shown in FIG. 6, viewed from a different angle. FIG. 8 is a block diagram specifically showing configurations of the measurement system and the correction processing apparatus according to the second example embodiment of the invention.

As shown in FIG. 6, in the measurement system 101 according to the second example embodiment, the measurement apparatus 20 and the imaging apparatus 30 are coupled to each other by a joint member 70. Also, with this configuration, in the second example embodiment, a correction processing apparatus 60 further includes a direction specifying unit 14 unlike the correction processing apparatus 10 according to the first example embodiment shown in FIGS. 1 and 2. The following mainly describes differences from the first example embodiment.

In the second example embodiment, the joint member 70 is an optical component that can change the angle, such as a ball joint, and couples the measurement apparatus 20 and the imaging apparatus 30 to each other such that the positional relationship therebetween can be changed. The imaging apparatus 30 is coupled to the measurement apparatus 20 by the joint member 70, and therefore the imaging apparatus 30 can also be used in a case where the reference face 50 is not set to be parallel with the measurement target area of the object 40 as shown in FIGS. 6 and 7.

Also, in FIGS. 6 and 7, the X axis is an axis that extends in the horizontal direction of the time-series images, the Y axis is an axis that extends in the vertical direction of the time-series images, and the z axis is an axis that extends in the normal direction of the reference face 50. Furthermore, the X′ axis is an axis that is parallel with the measurement target face, obtained by projecting the X axis onto the measurement target face, the Y′ axis is an axis that is parallel with the measurement target face, obtained by projecting the Y axis onto the measurement target face, and the Z′ axis is an axis that extends in the normal direction of the measurement target face.

Furthermore, as shown in FIG. 6, the rotational angle of the imaging apparatus 30 about the Y axis id denoted as α. As shown in FIG. 7, the rotational angle of the imaging apparatus 30 about the X axis is denoted as β. The rotational angles α and β are set by adjusting the orientation of the imaging apparatus 30 according to the inclination of the reference face 50 such that the normal of the light-receiving surface of the solid-state imaging sensor of the imaging apparatus 30 is parallel with the normal of the reference face 50 (the Z axis).

Also, the orientation of the imaging apparatus 30 can be adjusted using a distance measurement apparatus such as a laser distance meter. Specifically, first, the distance measurement apparatus is attached to the imaging apparatus 30 such that the measurement direction of the distance measurement apparatus coincides with the normal direction of the light-receiving surface of the solid-state imaging sensor. Thereafter, a position at which the distance measured by the distance measurement apparatus is the shortest is specified while the orientation of the imaging apparatus 30 is adjusted. At this specified position, the measure distance is the shortest, and therefore the normal of the light-receiving surface of the solid-state imaging sensor coincides with the normal of the reference face 50. Therefore, the orientation of the imaging apparatus 30 is fixed at this position. Also, an administrator or the like measures the rotational angle α and the rotational angle β when the imaging apparatus 30 is fixed, and inputs the measured value to the correction processing apparatus 10.

The direction specifying unit 14 specifies the positional relationship between the measurement apparatus 20 and the imaging apparatus 30, and specifies directions that correspond to the specific directions of the reference face 50 on the time-series images based on the specified positional relationship.

In the second example embodiment, the correction processing unit 13 corrects the second amount of movement based on the directions corresponding to the specific directions specified by the direction specifying unit 14. Also, using the corrected second amount of movement, the correction processing unit 13 corrects the vibrations measured by the measurement apparatus 20 so as to be vibrations relative to the reference face 50.

Specifically, as shown in FIG. 8, the direction specifying unit 14 specifies the positional relationship between the measurement apparatus 20 and the imaging apparatus 30 by acquiring the rotational angle α and the rotational angle β that have been input. Also, the direction specifying unit 14 calculates the relationship between the X, Y, and Z axes and the X′, Y′, and Z′ axes by applying the acquired rotational angle α to Math. 15 or applying the rotational angle β to Math. 16 shown below. Based on these relationships between axes, the directions corresponding to the specific directions in which vibrations have been measured, of the reference face on the time-series images, are specified.

$$\begin{matrix}( \begin{matrix}{x}^{′} \\ {y}^{′} \\ {z}^{′} \\ 1\end{matrix} ) = ( \begin{matrix}1 & 0 & 0 & 0 \\ 0 & cos a & - sin a & 0 \\ 0 & sin a & cos a & 0 \\ 0 & 0 & 0 & 1\end{matrix} ) ( \begin{matrix}x \\ y \\ z \\ 1\end{matrix} ) & [ Math . 15 ] \\ ( \begin{matrix}{x}^{′} \\ {y}^{′} \\ {z}^{′} \\ 1\end{matrix} ) = ( \begin{matrix}cos β & 0 & sin β & 0 \\ 0 & 1 & 0 & 0 \\ - sin β & 0 & cos β & 0 \\ 0 & 0 & 0 & 1\end{matrix} ) ( \begin{matrix}x \\ y \\ z \\ 1\end{matrix} ) & [ Math . 16 ]\end{matrix}$$

Based on these relationships between axes, the directions corresponding to the specific directions in which vibrations have been measured, of the reference face on the time-series images, are specified. For example, it is assumed that the rotational angle α=45° and the rotational angle β=0°. In this case, the relationship indicated by Math. 17 below is specified.

X′=X

Y′=−(Y+Z)/2^{1/2}

Z′=(Y−Z)/2^{1/2} [Math. 17]

As shown in FIG. 8, the correction processing unit 13 corrects the amount of movement calculated by the movement amount calculation unit 12, based on the specified relationship between axes. The amount of movement to be corrected is, for example, the amount of movement “A−B”=(dxa−dxb,dya−dyb,dza−dzb) of the imaging apparatus 30 relative to the reference face 50. Therefore, when the rotational angle α=135° and the rotational angle β=0°, the corrected amount of movement is as indicated by Math. 18 below.

The corrected “A−B”=(dxa−dxb,−(dya−dyb+dza−dzb)2^{1/2}, (dya−dyb−dza+dzb)2^{1/2}) [Math. 18]

Thereafter, the correction processing unit 13 calculates vibrations of the object 40 relative to the reference face 50 by subtracting the corrected amount of movement of the measurement apparatus 20 relative to the reference face 50 from vibrations measured by the measurement apparatus 20.

Apparatus Operations

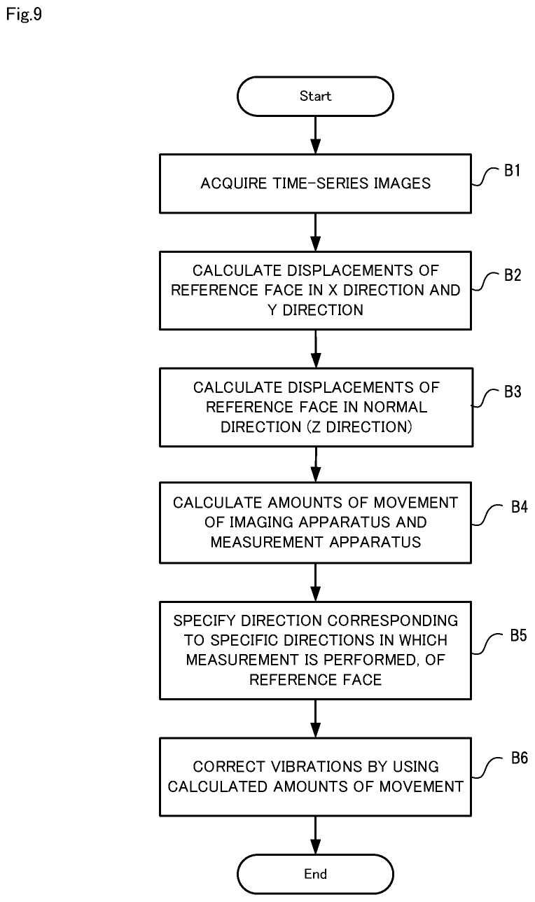

Next, operations of the measurement system 101 and the correction processing apparatus 60 according to the second example embodiment of the invention will be described with reference to FIG. 9. FIG. 9 is a flowchart showing operations of the measurement system and the correction processing apparatus according to the second example embodiment of the invention. In the following description, FIGS. 4 to 8 will be referenced as appropriate. Also, in the second example embodiment, a correction processing method is performed by operating the correction processing apparatus 10. Therefore, the following description of operations of the correction processing apparatus 60 substitutes for a description of a correction processing method according to the second example embodiment.

As shown in FIG. 9, first, the displacement calculation unit 11 in the correction processing apparatus 10 acquires the image data of time-series images output from the imaging apparatus 30 (step B1). Step B1 is the same as step A1 shown in FIG. 3.

Next, the displacement calculation unit 11 determines one image from among the acquired time-series images as a reference image, determines the other images as processing images, and compares them with each other to calculate the displacement of the reference face 50 in the horizontal direction (the X direction) of the images and the displacement of the reference face 50 in the vertical direction (the Y direction) (step B2). Step B2 is the same as step A2 shown in FIG. 3.

Next, using the processing images, the reference image, and the displacements (d1x, d1y) of the reference face 50 calculated in step A2, the displacement calculation unit 11 calculates the magnification d1z indicating the displacement of the reference face 50 in the normal direction (the Z direction) (step B3). Step B3 is the same as step A3 shown in FIG. 3.

Next, the movement amount calculation unit 12 calculates the actual amounts of movement of the imaging apparatus 30 and the measurement apparatus 20, using the displacements (d1x, d1y) in the horizontal direction and the vertical direction calculated in step A2, the magnification d1z calculated in step A3, and imaging information regarding the imaging apparatus 30 (step B4). Step B4 is the same as step A4 shown in FIG. 3.

Next, the direction specifying unit 14 specifies the positional relationship between the measurement apparatus 20 and the imaging apparatus 30, and specifies directions that correspond to the specific directions of the reference face 50 on the time-series images based on the specified positional relationship (step B5). Specifically, in step B5, the direction specifying unit 14 calculates the relationship between the X, Y, and Z axes and the X′, Y′, and Z′ axes, using the rotational angle α and the rotational angle β, and specifies the directions corresponding to the specific directions.

Next, the correction processing unit 13 corrects the amount of movement obtained in step B4, based on the direction specified in step B5, and corrects the vibrations specified by the vibration data acquired from the measurement apparatus 20, so as to be vibrations of the object 40 relative to the reference face 50, using the corrected amounts of movement (step B6). Also, the correction processing unit 13 outputs data that specifies the corrected vibrations.

Specifically, the correction processing unit 13 corrects the amount of movement (the second amount of movement) “A−B” of the imaging apparatus 30 relative to the reference face 50, calculated in step A4, based on the direction specified in step B5. Then, the correction processing unit 13 acquires vibration data from the measurement apparatus 20, and specifies the amount of movement “C−B” of the measurement target area relative to the measurement apparatus 20, from the acquired vibration data. Thereafter, the correction processing unit 13 calculates vibrations of the object 40 relative to the reference face 50 by subtracting the corrected amount of movement (the second amount of movement) “A−B” of the imaging apparatus 30 relative to the reference face 50 from the specified amount of movement “C−B”.

As described above, according to the second example embodiment, the reference face 50 need not be a flat face. According to the second example embodiment, even if the reference face 50 is not a flat face, it is possible to accurately measure vibrations of the object 40 in the same manner as in the case where the reference face 50 is flat (the case of the first example embodiment).

Modification

The above example describes a case where the rotational angle α=135° and the rotational angle β. However, in the second example embodiment, the rotational angle α and the rotational angle β need only fall within the range of 0° to 180°. Also, in the second example embodiment, the values of both of the rotational angle α and the rotational angle β may be greater than 0 (zero).

Also, for example, when the rotational angle α=90° and the rotational angle β=90, the reference face 50 is orthogonal to the measurement target area, and the normal of the measurement target area and the normal of the reference face 50 are orthogonal to each other. In this case, vibrations of the measurement target area in the normal direction are to be corrected based on the amount of movement of the reference face on the time-series images in the horizontal direction or the vertical direction. According to this mode, it is possible to improve the accuracy of the measurement of vibrations of the measurement target area in the normal direction. This is because the amount of movement of the time-series images in the horizontal direction or the vertical direction can be more accurately calculated than the amount of movement of the reference face in the normal direction.

Program

A program according to the second example embodiment need only be a program that causes a computer to execute steps B1 to B6 shown in FIG. 9. The correction processing apparatus 60 and the correction processing method according to this example embodiment can be realized by installing this program to a computer and executing the program. In this case, a CPU (Central Processing Unit) of the computer functions as the displacement calculation unit 11, the movement amount calculation unit 12, the correction processing unit 13, and the direction specifying unit 14, and performs processing.

The program according to the second example embodiment may be executed by a computer system that is established from a plurality of computers. In this case, for example, each computer may function as one of the displacement calculation unit 11, the movement amount calculation unit 12, the correction processing unit 13, and the direction specifying unit 14.

Physical Configuration

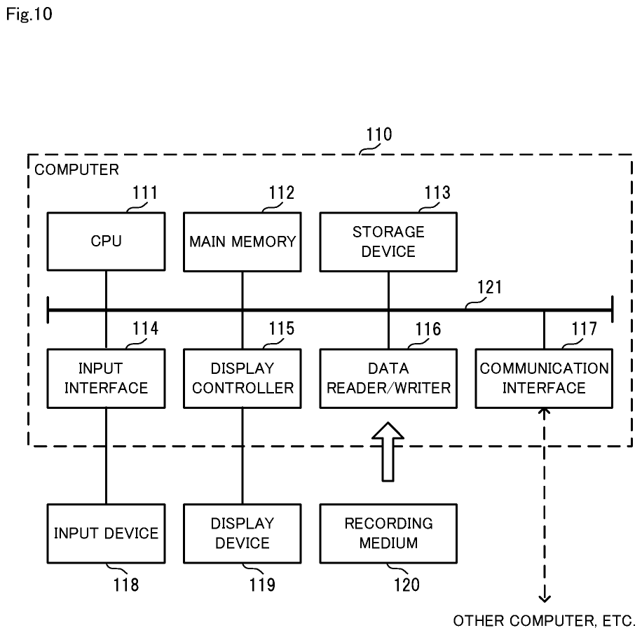

Hereinafter, a computer that realizes a correction processing apparatus by executing a program according to the first or second example embodiment will be described with reference to FIG. 10. FIG. 10 is a block diagram showing an example of a computer that realizes the correction processing apparatuses according to the first or second example embodiment.

As shown in FIG. 10, a computer 110 includes a CPU 111, a main memory 112, a storage device 113, an input interface 114, a display controller 115, a data reader/writer 116, and a communication interface 117. These units are connected to each other via a bus 121 so as to be able to perform data communication with each other.

The CPU 111 loads a program (codes) according to the example embodiments, stored in the storage device 113, onto the main memory 112, and executes the codes in a predetermined order to perform various calculations. The main memory 112 is typically a volatile storage device such as a DRAM (Dynamic Random Access Memory). The program according to the example embodiments is provided in a state of being stored in a computer-readable recording medium 120. Note that the program according to the example embodiments may be distributed over the Internet connected via the communication interface 117.

Specific examples of the storage device 113 include, in addition to a hard disk drive, a semiconductor storage device such as a flash memory. The input interface 114 mediates data transmission between the CPU 111 and an input device 118 such as a keyboard or a mouse. The display controller 115 is connected to a display device 119 and controls display by the display device 119.

The data reader/writer 116 mediates data transmission between the CPU 111 and the recording medium 120, and executes readout of programs from the recording medium 120 and writing of processing results of the computer 110 to the recording medium 120. The communication interface 117 mediates data transmission between the CPU 111 and another computer.

Specific examples of the recording medium 120 include a general-purpose semiconductor storage device such as a CF (Compact Flash (registered trademark)) or an SD (Secure Digital) card, a magnetic storage medium such as a flexible disk, and an optical storage medium such as a CD-ROM (Compact Disk Read Only Memory).

Note that the correction processing apparatuses according to the example embodiments can also be realizable by using hardware corresponding to the respective units, rather than by a computer on which the program is installed. Furthermore, the correction processing apparatuses may respectively be realized in part by a program, and the remaining portion may be realized by hardware.

The example embodiments described above can be partially or wholly realized by supplementary notes 1 to 16 described below, but the invention is not limited to the following description.

Supplementary Note 1

A measurement system comprising: a measurement apparatus that measures vibrations of an object; an imaging apparatus that is fixed to the measurement apparatus so as to be able to capture an image of a preset reference face; and a correction processing apparatus,

the correction processing apparatus comprising:

a displacement calculation unit that calculates a displacement of the reference face based on time-series images of the reference face output from the imaging apparatus;

a movement amount calculation unit that calculates an amount of movement of the measurement apparatus relative to the reference face, based on the displacement and preset imaging information regarding the imaging apparatus; and

a correction processing unit that corrects vibrations measured by the measurement apparatus, so as to be vibrations relative to the reference face, using the amount of movement.

Supplementary Note 2

The measurement system according to Supplementary Note 1,

wherein the measurement apparatus measures vibrations of the object in a specific direction,

the correction processing apparatus further comprises a direction specifying unit that specifies a positional relationship between the measurement apparatus and the imaging apparatus, and specifies a direction corresponding to the specific direction of the reference face on the time-series images, based on the specified positional relationship, and

the correction processing unit corrects the amount of movement based on the direction corresponding to the specified specific direction, and corrects vibrations measured by the measurement apparatus, so as to be vibrations relative to the reference face, using the corrected amount of movement.

Supplementary Note 3

The measurement system according to Supplementary Note 2,

wherein, when the specific direction comprises at least a normal direction of a face where vibrations of the object are measured, and a normal of the face where vibrations of the object are measured and a normal of the reference face are orthogonal to each other,

the direction specifying unit specifies a direction that is parallel with the reference face, as a direction corresponding to the normal direction of the face where vibrations of the object are measured.

Supplementary Note 4

The measurement system according to any one of Supplementary Notes 1 to 3,

wherein the specific direction comprises three directions constituted by two directions that are orthogonal to each other on the face where vibrations of the object are measured, and the normal direction of the face where vibrations of the object are measured, and

the movement amount calculation unit calculates the amount of movement for each of three directions respectively corresponding to the three directions.

Supplementary Note 5

A correction processing apparatus for correcting a result of measurement performed by a measurement apparatus that measures vibrations of an object, the correction processing apparatus comprising:

a displacement calculation unit that calculates a displacement of a preset reference face based on time-series images of the reference face output from an imaging apparatus that is fixed to the measurement apparatus so as to be able to capture an image of the reference face;

a movement amount calculation unit that calculates an amount of movement of the measurement apparatus relative to the reference face, based on the displacement and preset imaging information regarding the imaging apparatus; and

a correction processing unit that corrects vibrations measured by the measurement apparatus, so as to be vibrations relative to the reference face, using the amount of movement.

Supplementary Note 6

The correction processing apparatus according to Supplementary Note 5,

wherein the measurement apparatus measures vibrations of the object in a specific direction,

the correction processing apparatus further comprises a direction specifying unit that specifies a positional relationship between the measurement apparatus and the imaging apparatus, and specifies a direction corresponding to the specific direction of the reference face on the time-series images, based on the specified positional relationship, and

the correction processing unit corrects the amount of movement based on the direction corresponding to the specified specific direction, and corrects vibrations measured by the measurement apparatus, so as to be vibrations relative to the reference face, using the corrected amount of movement.

Supplementary Note 7

The correction processing apparatus according to Supplementary Note 6, wherein, when the specific direction comprises at least a normal direction of a face where vibrations of the object are measured, and a normal of the face where vibrations of the object are measured and a normal of the reference face are orthogonal to each other,

the direction specifying unit specifies a direction that is parallel with the reference face, as a direction corresponding to the normal direction of the face where vibrations of the object are measured.

Supplementary Note 8

The correction processing apparatus according to any one of Supplementary Notes 5 to 7,

wherein the specific direction comprises three directions constituted by two directions that are orthogonal to each other on the face where vibrations of the object are measured, and the normal direction of the face where vibrations of the object are measured, and

the movement amount calculation unit calculates the amount of movement for each of three directions respectively corresponding to the three directions.

Supplementary Note 9

A correction processing method for correcting a result of measurement performed by a measurement apparatus that measures vibrations of an object, the correction processing method comprising:

(a) a step of calculating a displacement of a preset reference face based on time-series images of the reference face output from an imaging apparatus that is fixed to the measurement apparatus so as to be able to capture an image of the reference face;

(b) a step of calculating an amount of movement of the measurement apparatus relative to the reference face, based on the displacement and preset imaging information regarding the imaging apparatus; and

(c) a step of correcting vibrations measured by the measurement apparatus, so as to be vibrations relative to the reference face, using the amount of movement.

Supplementary Note 10

The correction processing method according to Supplementary Note 9, further comprising:

(d) a step of, when the measurement apparatus measures vibrations of the object in a specific direction, specifying a positional relationship between the measurement apparatus and the imaging apparatus, and specifying a direction corresponding to the specific direction of the reference face on the time-series images, based on the specified positional relationship, and

in the (c) step, the amount of movement is corrected based on the direction corresponding to the specified specific direction, and vibrations measured by the measurement apparatus are corrected so as to be vibrations relative to the reference face, using the corrected amount of movement.

Supplementary Note 11

The correction processing method according to Supplementary Note 10,

wherein, when the specific direction comprises at least a normal direction of a face where vibrations of the object are measured, and a normal of the face where vibrations of the object are measured and a normal of the reference face are orthogonal to each other,

in the (d) step, a direction that is parallel with the reference face is specified as a direction corresponding to the normal direction of the face where vibrations of the object are measured.

Supplementary Note 12

The correction processing method according to any one of Supplementary Notes 9 to 11,

wherein the specific direction comprises three directions constituted by two directions that are orthogonal to each other on the face where vibrations of the object are measured, and the normal direction of the face where vibrations of the object are measured, and

in the (b) step, the amount of movement is calculated for each of three directions respectively corresponding to the three directions.

Supplementary Note 13

A computer-readable recording medium having recorded thereon a program for correcting a result of measurement performed by a measurement apparatus that measures vibrations of an object, using a computer,

the program including instructions that cause the computer to carry out:

(a) a step of calculating a displacement of a preset reference face based on time-series images of the reference face output from an imaging apparatus that is fixed to the measurement apparatus so as to be able to capture an image of the reference face;

(b) a step of calculating an amount of movement of the measurement apparatus relative to the reference face, based on the displacement and preset imaging information regarding the imaging apparatus; and

(c) a step of correcting vibrations measured by the measurement apparatus, so as to be vibrations relative to the reference face, using the amount of movement.

Supplementary Note 14

The computer-readable recording medium according to Supplementary Note 13,

wherein the program further includes an instruction that causes the computer to carry out

(d) a step of, when the measurement apparatus measures vibrations of the object in a specific direction, specifying a positional relationship between the measurement apparatus and the imaging apparatus, and specifying a direction corresponding to the specific direction of the reference face on the time-series images, based on the specified positional relationship, and

in the (c) step, the amount of movement is corrected based on the direction corresponding to the specified specific direction, and vibrations measured by the measurement apparatus are corrected so as to be vibrations relative to the reference face, using the corrected amount of movement.

Supplementary Note 15

The computer-readable recording medium according to Supplementary Note 14,

wherein, when the specific direction comprises at least a normal direction of a face where vibrations of the object are measured, and a normal of the face where vibrations of the object are measured and a normal of the reference face are orthogonal to each other,

in the (d) step, a direction that is parallel with the reference face is specified as a direction corresponding to the normal direction of the face where vibrations of the object are measured.

Supplementary Note 16

The computer-readable recording medium according to any one of Supplementary Notes 13 to 15,

wherein the specific direction comprises three directions constituted by two directions that are orthogonal to each other on the face where vibrations of the object are measured, and the normal direction of the face where vibrations of the object are measured, and

in the (b) step, the amount of movement is calculated for each of three directions respectively corresponding to the three directions.

Although the present invention has been described above with reference to example embodiments, the invention is not limited to the example embodiments described above. Various modifications apparent to those skilled in the art can be made to the configurations and details of the invention within the scope of the invention.

### INDUSTRIAL APPLICABILITY

As described above, according to the invention, it is possible to accurately measure vibrations of an object even if the measurement apparatus that measures vibrations of the object is installed in a location that is likely to be vibrated. The invention is useful in the field of maintenance and management, and abnormality detection, of infrastructural components such as bridges, roads, buildings, and facilities.

### LIST OF REFERENCE SIGNS

10: Correction Processing Apparatus (First Example Embodiment)

11: Displacement Calculation Unit

12: Movement Amount Calculation Unit

13: Correction Processing Unit

14: Direction Specifying Unit

20: Measurement Apparatus

30: Imaging Apparatus

40: Object

50: Reference Face

60: Correction Processing Apparatus (Second Example Embodiment)

70: Joint Member

100: Measurement System (First Example Embodiment)

101: Measurement System (Second Example Embodiment)

110: Computer

111: CPU

112: Main Memory

113: Storage Device

114: Input Interface

115: Display Controller

116: Data Reader/Writer

117: Communication Interface

118: Input Device

119: Display Device

120: Recording Medium

121: Bus

What is claimed is:

1. A measurement system comprising: a measurement apparatus that measures vibrations of an object; an imaging apparatus that is fixed to the measurement apparatus so as to be able to capture an image of a preset reference face; and a correction processing apparatus,
the correction processing apparatus comprising:
a displacement calculation unit that calculates a displacement of the reference face based on time-series images of the reference face output from the imaging apparatus;
a movement amount calculation unit that calculates an amount of movement of the measurement apparatus relative to the reference face, based on the displacement and preset imaging information regarding the imaging apparatus; and
a correction processing unit that corrects vibrations measured by the measurement apparatus, so as to be vibrations relative to the reference face, using the amount of movement.

2. The measurement system according to claim 1,
wherein the measurement apparatus measures vibrations of the object in a specific direction,
the correction processing apparatus further comprises a direction specifying unit that specifies a positional relationship between the measurement apparatus and the imaging apparatus, and specifies a direction corresponding to the specific direction of the reference face on the time-series images, based on the specified positional relationship, and
the correction processing unit corrects the amount of movement based on the direction corresponding to the specified specific direction, and corrects vibrations measured by the measurement apparatus, so as to be vibrations relative to the reference face, using the corrected amount of movement.

3. The measurement system according to claim 2,
wherein, when the specific direction comprises at least a normal direction of a face where vibrations of the object are measured, and a normal of the face where vibrations of the object are measured and a normal of the reference face are orthogonal to each other,
the direction specifying unit specifies a direction that is parallel with the reference face, as a direction corresponding to the normal direction of the face where vibrations of the object are measured.

4. The measurement system according to claim 1,
wherein the specific direction comprises three directions constituted by two directions that are orthogonal to each other on the face where vibrations of the object are measured, and the normal direction of the face where vibrations of the object are measured, and
the movement amount calculation unit calculates the amount of movement for each of three directions respectively corresponding to the three directions.

5. A correction processing apparatus for correcting a result of measurement performed by a measurement apparatus that measures vibrations of an object, the correction processing apparatus comprising:
a displacement calculation unit that calculates a displacement of a preset reference face based on time-series images of the reference face output from an imaging apparatus that is fixed to the measurement apparatus so as to be able to capture an image of the reference face;
a movement amount calculation unit that calculates an amount of movement of the measurement apparatus relative to the reference face, based on the displacement and preset imaging information regarding the imaging apparatus; and
a correction processing unit that corrects vibrations measured by the measurement apparatus, so as to be vibrations relative to the reference face, using the amount of movement.

6. The correction processing apparatus according to claim 5,
wherein the measurement apparatus measures vibrations of the object in a specific direction,
the correction processing apparatus further comprises a direction specifying unit that specifies a positional relationship between the measurement apparatus and the imaging apparatus, and specifies a direction corresponding to the specific direction of the reference face on the time-series images, based on the specified positional relationship, and
the correction processing unit corrects the amount of movement based on the direction corresponding to the specified specific direction, and corrects vibrations measured by the measurement apparatus, so as to be vibrations relative to the reference face, using the corrected amount of movement.

7. The correction processing apparatus according to claim 6,
wherein, when the specific direction comprises at least a normal direction of a face where vibrations of the object are measured, and a normal of the face where vibrations of the object are measured and a normal of the reference face are orthogonal to each other,
the direction specifying unit specifies a direction that is parallel with the reference face, as a direction corresponding to the normal direction of the face where vibrations of the object are measured.

8. The correction processing apparatus according to claim 5,
wherein the specific direction comprises three directions constituted by two directions that are orthogonal to each other on the face where vibrations of the object are measured, and the normal direction of the face where vibrations of the object are measured, and
the movement amount calculation unit calculates the amount of movement for each of three directions respectively corresponding to the three directions.

9. A correction processing method for correcting a result of measurement performed by a measurement apparatus that measures vibrations of an object, the correction processing method comprising:
calculating a displacement of a preset reference face based on time-series images of the reference face output from an imaging apparatus that is fixed to the measurement apparatus so as to be able to capture an image of the reference face;
calculating an amount of movement of the measurement apparatus relative to the reference face, based on the displacement and preset imaging information regarding the imaging apparatus; and
correcting vibrations measured by the measurement apparatus, so as to be vibrations relative to the reference face, using the amount of movement.

10. The correction processing method according to claim 9, further comprising:
when the measurement apparatus measures vibrations of the object in a specific direction, specifying a positional relationship between the measurement apparatus and the imaging apparatus, and specifying a direction corresponding to the specific direction of the reference face on the time-series images, based on the specified positional relationship, and
the amount of movement is corrected based on the direction corresponding to the specified specific direction, and vibrations measured by the measurement apparatus are corrected so as to be vibrations relative to the reference face, using the corrected amount of movement.

11. The correction processing method according to claim 10,
wherein, when the specific direction comprises at least a normal direction of a face where vibrations of the object are measured, and a normal of the face where vibrations of the object are measured and a normal of the reference face are orthogonal to each other,
a direction that is parallel with the reference face is specified as a direction corresponding to the normal direction of the face where vibrations of the object are measured.

12. The correction processing method according to claim 9,
wherein the specific direction comprises three directions constituted by two directions that are orthogonal to each other on the face where vibrations of the object are measured, and the normal direction of the face where vibrations of the object are measured, and
the amount of movement is calculated for each of three directions respectively corresponding to the three directions.

13. A non-transitory computer-readable recording medium having recorded thereon a program for correcting a result of measurement performed by a measurement apparatus that measures vibrations of an object, using a computer,
the program including instructions that cause the computer to carry out:
calculating a displacement of a preset reference face based on time-series images of the reference face output from an imaging apparatus that is fixed to the measurement apparatus so as to be able to capture an image of the reference face;
calculating an amount of movement of the measurement apparatus relative to the reference face, based on the displacement and preset imaging information regarding the imaging apparatus; and
correcting vibrations measured by the measurement apparatus, so as to be vibrations relative to the reference face, using the amount of movement.

14. The non-transitory computer-readable recording medium according to claim 13,
wherein the program further includes an instruction that causes the computer to carry out
when the measurement apparatus measures vibrations of the object in a specific direction, specifying a positional relationship between the measurement apparatus and the imaging apparatus, and specifying a direction corresponding to the specific direction of the reference face on the time-series images, based on the specified positional relationship, and
the amount of movement is corrected based on the direction corresponding to the specified specific direction, and vibrations measured by the measurement apparatus are corrected so as to be vibrations relative to the reference face, using the corrected amount of movement.

15. The non-transitory computer-readable recording medium according to claim 14,
wherein, when the specific direction comprises at least a normal direction of a face where vibrations of the object are measured, and a normal of the face where vibrations of the object are measured and a normal of the reference face are orthogonal to each other,
a direction that is parallel with the reference face is specified as a direction corresponding to the normal direction of the face where vibrations of the object are measured.

16. The non-transitory computer-readable recording medium according to claim 13,
wherein the specific direction comprises three directions constituted by two directions that are orthogonal to each other on the face where vibrations of the object are measured, and the normal direction of the face where vibrations of the object are measured, and
the amount of movement is calculated for each of three directions respectively corresponding to the three directions.
